(19) United States
(12) Patent Application Publication
(10) Pub. No.: US 2026/0351703 A1
(43) Pub. Date: Nov. 5, 2026

(54) TEMPERATURE SENSOR FAULT ACTIVE SIGNAL DEBOUNCE FOR VEHICLE BATTERY SYSTEM THERMAL RUNAWAY MONITORING

(71) Applicant: FCA US LLC, Auburn Hills, MI (US)

(72) Inventors: Andrew Philip White, Auburn Hills, MI (US); Atheel Antwan Saleem, Auburn Hills, MI (US); Nicholas Gregory Firsich, Auburn Hills, MI (US)

(21) Appl. No.: 19/194,691

(22) Filed: Apr. 30, 2025

(51) Int. Cl. H01M 10/48; G01K 3/00; H01M 10/42

(52) U.S. Cl. CPC H01M 10/488; G01K 3/005; H01M 10/425; H01M 10/486; H01M 2010/4278; H01M 2220/20

(57) ABSTRACT

Thermal runaway monitoring systems and methods for a high voltage battery system of an electrified vehicle include a battery pack control module (BPCM) configured to receive, from a temperature sensor, a measured temperature of a battery module of the high voltage battery system, generate a high/low fault active signal indicative of whether the measured temperature from the temperature sensor is invalid or valid, respectively, utilize a falling edge debounce on the fault active signal to control accumulation of a cumulative temperature rise for thermal runaway monitoring of the high voltage battery system, and detect a thermal runaway event of the high voltage battery system and generate a thermal runaway malfunction warning when the cumulative temperature rise exceeds a cumulative temperature rise threshold.

### FIELD

The present application generally relates to electrified vehicles and, more particularly, to a temperature sensor fault active signal debounce technique high voltage battery system thermal runaway monitoring.

### BACKGROUND

An electrified vehicle includes a high voltage battery pack or system that is configured to power one or more electric traction motors for vehicle propulsion. The battery system includes a plurality of battery modules, each of which includes a plurality of battery cells. Each battery module has a temperature sensor configured to monitor temperature variations therein. A battery pack control module (BPCM) is a specific vehicle controller that monitors these temperature sensors for various reasons including thermal runaway monitoring. Thermal runaway refers to a very serious uncontrollable battery self-heating condition that could potentially cause a fire. When thermal runaway is detected, the vehicle occupants are typically instructed to safely exit the vehicle. Inaccurate or false positive thermal runaway detections, however, could be aggravating to customers. Accordingly, while such conventional vehicle battery system thermal runaway monitoring techniques do work for their intended purpose, there exists an opportunity for improvement in the relevant art.

### SUMMARY

According to one aspect of the invention, a thermal runaway monitoring system for a high voltage battery system of an electrified vehicle is presented. In one exemplary implementation, the thermal runaway monitoring system comprises a temperature sensor configured to measure a temperature of a battery module of the high voltage battery system and a battery pack control module (BPCM) configured to receive, from the temperature sensor, the measured temperature, generate a high/low fault active signal indicative of whether the measured temperature from the temperature sensor is invalid or valid, respectively, utilize a falling edge debounce on the fault active signal to control accumulation of a cumulative temperature rise for thermal runaway monitoring of the high voltage battery system, and detect a thermal runaway event of the high voltage battery system and generate a thermal runaway malfunction warning when the cumulative temperature rise exceeds a cumulative temperature rise threshold, wherein the utilization of the falling edge debounce on the fault active signal mitigates or eliminates false positive thermal runaway detections caused by the cumulative temperature rise accumulating in response to invalid-to-valid transitions of the fault active signal and spikes in the corresponding measured temperature from the temperature sensor.

In some implementations, the BPCM is a wireless BPCM that is configured to wirelessly communicate with the temperature sensor. In some implementations, the BPCM is further configured to, in response to a temporary wireless communication loss between the BPCM and the temperature sensor, set the fault active signal high indicating an invalid measured temperature from the temperature sensor. In some implementations, the BPCM is further configured to, in response to a reestablishment of wireless communication between the BPCM and the temperature sensor after the temporary wireless communication loss therebetween, set the fault active signal low indicating a valid measured temperature from the temperature sensor.

In some implementations, the BPCM is further configured to, in response to a wakeup of the BPCM, set the fault active signal high indicating an invalid temperature measurement for a wakeup period. In some implementations, the BPCM is a wired BPCM that is in wired communication with the temperature sensor. In some implementations, the BPCM is further configured to, in response to a hardware malfunction of at least one of the temperature sensor, the BPCM, and a hardwired connection therebetween, set the fault active signal high indicating a valid measured temperature from the temperature sensor. In some implementations, the thermal runaway malfunction warning instructs occupants of the electrified vehicle to safely exit and move away from the electrified vehicle.

In some implementations, the temperature sensor is one of a plurality of temperature sensors for a plurality of battery modules, including the battery module, of the high voltage battery system, wherein each battery module comprises a plurality of battery cells, and wherein the BPCM is configured to receive the measured temperatures of the plurality of battery modules from the plurality of temperature sensors and perform thermal runaway monitoring based thereon.

According to another aspect of the invention, a thermal runaway monitoring method for a high voltage battery system of an electrified vehicle is presented. In one exemplary implementation, the thermal runaway monitoring method comprises measuring, by a temperature sensor, a temperature of a battery module of the high voltage battery system, receiving, by a BPCM and from the temperature sensor, the measured temperature, generating, by the BPCM, a high/low fault active signal indicative of whether the measured temperature from the temperature sensor is invalid or valid, respectively, utilizing, by the BPCM, a falling edge debounce on the fault active signal to control accumulation of a cumulative temperature rise for thermal runaway monitoring of the high voltage battery system, and detecting, by the BPCM, a thermal runaway event of the high voltage battery system and generate a thermal runaway malfunction warning when the cumulative temperature rise exceeds a cumulative temperature rise threshold, wherein the utilizing of the falling edge debounce on the fault active signal mitigates or eliminates false positive thermal runaway detections caused by the cumulative temperature rise accumulating in response to invalid-to-valid transitions of the fault active signal and spikes in the corresponding measured temperature from the temperature sensor.

In some implementations, the BPCM is a wireless BPCM that is configured to wirelessly communicate with the temperature sensor. In some implementations, the thermal runaway monitoring method further comprises, in response to a temporary wireless communication loss between the BPCM and the temperature sensor, setting, by the BPCM, the fault active signal high indicating an invalid measured temperature from the temperature sensor. In some implementations, the thermal runaway monitoring method further comprises, in response to a reestablishment of wireless communication between the BPCM and the temperature sensor after the temporary wireless communication loss therebetween, setting, by the BPCM, the fault active signal low indicating a valid measured temperature from the temperature sensor.

In some implementations, the thermal runaway monitoring method further comprises, in response to a wakeup of the BPCM, setting, by the BPCM, the fault active signal high indicating an invalid temperature measurement for a wakeup period. In some implementations, the BPCM is a wired BPCM that is in wired communication with the temperature sensor. In some implementations, the thermal runaway monitoring method further comprises in response to a hardware malfunction of at least one of the temperature sensor, the BPCM, and a hardwired connection therebetween, set the fault active signal high indicating a valid measured temperature from the temperature sensor. In some implementations, the thermal runaway malfunction warning instructs occupants of the electrified vehicle to safely exit and move away from the electrified vehicle.

In some implementations, the temperature sensor is one of a plurality of temperature sensors for a plurality of battery modules, including the battery module, of the high voltage battery system, wherein each battery module comprises a plurality of battery cells, and wherein the BPCM is configured to receive the measured temperatures of the plurality of battery modules from the plurality of temperature sensors and perform thermal runaway monitoring based thereon.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle having an example thermal runaway monitoring system for a high voltage battery system according to the principles of the present application; and

FIG. 2 is a flow diagram of example thermal runaway monitoring method for a high voltage battery system of an electrified vehicle according to the principles of the present application.

### DESCRIPTION

As previously discussed, an electrified vehicle includes a high voltage battery pack or system that is configured to power one or more electric traction motors for vehicle propulsion. The battery system includes a plurality of battery modules, each of which includes a plurality of battery cells. Each battery module has a temperature sensor configured to monitor temperature variations therein. A battery pack control module (BPCM) is a specific vehicle controller that monitors these temperature sensors for various reasons including thermal runaway monitoring. Thermal runaway refers to a very serious uncontrollable battery self-heating condition that could potentially cause a fire. When thermal runaway is detected, the vehicle occupants are typically instructed to safely exit the vehicle. Inaccurate or false positive thermal runaway detections, however, could be aggravating to customers. These false positive detections often occur when temperature sensor measurements are invalid.

In some cases, however, the temperature sensor measurements are known to be invalid (e.g., upon BPCM wakeup, during hardware interruptions, etc.). One previous solution to this problem utilizes an initialization timer at BPCM wakeup. This solution, however, does not properly address situations where temperature sensor measurements temporarily become invalid during the current operation cycle. In a particular electrified vehicle embodiment, the BPCM is a wireless BPCM. More specifically, the BPCM is configured to communicate via one or more short-range wireless communication mediums (Bluetooth, WiFi Direct, Zigbee, etc.), such as with the temperature sensors and/or a central controller or controller area network (CAN) of the electrified vehicle. Due to its wireless connectivity, the wireless BPCM could temporarily lose communication with the temperature sensors, thereby causing the temporarily invalid temperature sensor measurements and potential false positive thermal runaway detections.

Accordingly, improved thermal runaway monitoring systems and methods for a high voltage battery system of an electrified vehicle are presented herein. These systems and methods utilize a falling edge debounce on a temperature malfunction or fault active signal or flag to allow enough time for invalid temperature sensor measurements to pass through a cumulative temperature rise filter without impacting thermal runaway monitoring and detection. Debouncing refers to filtering technique to remove unwanted brief and rapid changes in a signal that could be caused by noise or other issues like a switch bounce, and falling edge debouncing refers to a specific debouncing technique that focuses on detecting and filtering only high-to-low transitions of a signal. These techniques avoid false detection of thermal runaway when temperature sensor measurements transition from invalid to valid. Potential benefits of these techniques include mitigated or eliminated false positive thermal runaway detections and an improved customer experience.

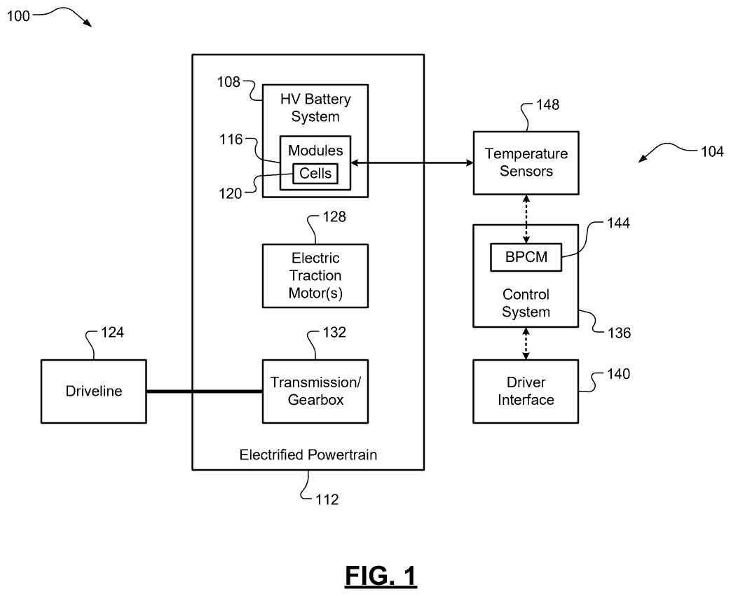

Referring now to FIG. 1, a functional block diagram of an electrified vehicle 100 having an example thermal runaway monitoring system 104 for a high voltage (HV) battery system 108 according to the principles of the present application is illustrated. The HV battery system 108 (also “battery system 108” herein) is part of an electrified powertrain 112 of the electrified vehicle 100 and the battery system 108 further comprises a plurality of battery modules 116 each comprising a plurality of battery cells 120. It will be appreciated that the battery system 108 could have any suitable configuration (e.g., a 400V or 800V DC battery system, which could comprise, for example only, 13 modules each comprising 8 lithium-ion type battery cells). The electrified powertrain 112 is configured to generate and transfer drive torque to a driveline 124 for vehicle propulsion. More specifically, one or more electric traction motors 128 (e.g., one or more interior permanent magnet synchronous motors, or IPMSMs) are configured to be powered by the battery system 108 (e.g., via a three-phase inverter) and the electric traction motor(s) 128 is/are configured to generate drive torque that can be transferred to the driveline 124 via an optional transmission, gearbox, or gear reducer 132.

A control system 136, which comprises a plurality of controllers or electronic control units (ECUs) connected or in communication with each other via a controller area network (CAN) or other suitable network, controls operation of the electrified vehicle 100, which primarily includes controlling the electrified powertrain 112 to generate and transfer to the driveline 124 a sufficient amount of drive torque to satisfy a driver torque request (e.g., received from a driver of the electrified vehicle 100 via a driver interface 140, such as an accelerator pedal device). For purposes of the present application, the control system 136 is shown to specifically include a BPCM 144, which controls/monitors the battery system 108, including receiving temperature measurements of the modules 116 or cells 120 via a plurality of temperature sensors 148. The control system 136 (or, more specifically, the BPCM 144) is further configured to execute at least a portion of the thermal runaway monitoring techniques of the present application.

As mentioned above, the BPCM 144 receives measured temperatures from the plurality of temperature sensors 148. For simplicity, only a single temperature sensor 148 for a single battery module 116 may be referenced at times herein. The measured temperature from the temperature sensor 148 can at times be invalid (as opposed to valid). Non-limiting examples of the measured temperature from the temperature sensor 148 being considered invalid include a wakeup event or wakeup period of the BPCM 144 or during communication malfunctions between the BPCM 144 and the temperature sensor. In one example embodiment, the BPCM 144 is a wireless BPCM that wirelessly communicates with the temperature sensor 148 via a short-range wireless communication medium (Bluetooth, WiFi Direct, Zigbee, etc.) and this communication link could temporarily break or be interrupted and then subsequently reestablished. A wireless implementation for the BPCM 144 allows for more flexible vehicle packaging, but it also presents the challenges discussed in detail herein due to temporary communication losses.

In another example embodiment, the BPCM 144 is hardwired to the temperature sensor 144 and a hardware malfunction (at the BPCM 144, at the temperature sensor 148, at the physical wiring therebetween, or elsewhere, such as a memory corruption) could cause a temporary communication loss between the BPCM 144 and the temperature sensor 148 and, in turn, the invalid measured temperature therefrom. When the measured temperature is invalid, the measured temperature should not be used or relied upon for temperature-based controls or monitoring, including thermal runaway monitoring. During such conditions, therefore, the BPCM 144 can generate or set/maintain a malfunction or fault active signal that indicates whether the measured temperature from the temperature sensor 148 is considered to be invalid (fault active=HIGH) or valid (fault active=LOW). During transitions from invalid-to-valid, however, a spike in the measured temperature (e.g., from ~0 °C to hundreds of °C) could occur, which could cause excessive temperature change accumulation that could inadvertently trigger a thermal runaway malfunction event detection.

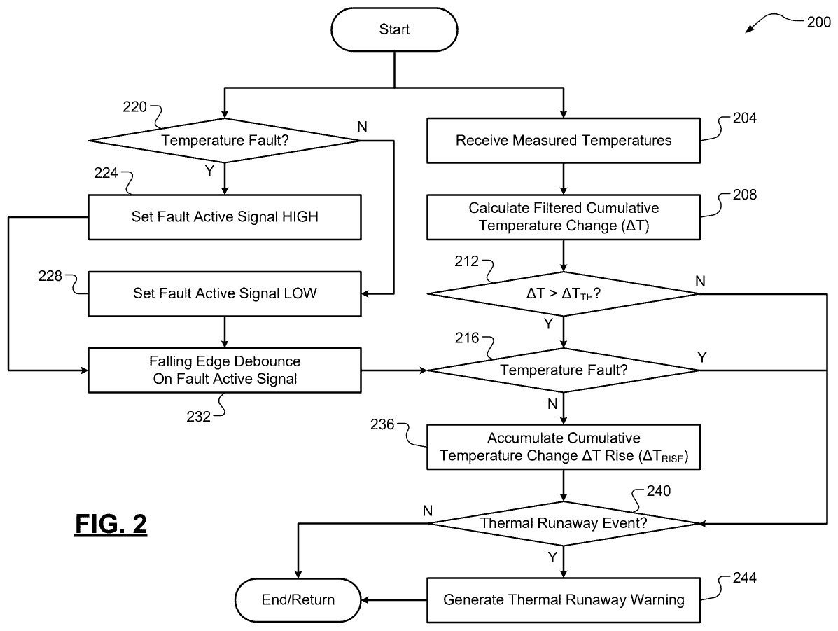

Referring now to FIG. 2 and with continued reference to FIG. 1, a flow diagram of an example thermal runaway monitoring method 200 for a high voltage battery system of an electrified vehicle according to the principles of the present application is illustrated. While the method 200 specifically references the electrified vehicle 100 and its components (e.g., the battery system 108 and the BPCM 144), it will be appreciated that the method 200 could be applicable to any suitably configured electrified vehicle having a high voltage battery system with temperature sensor(s) and a wireless or hardwired BPCM. The method 200 initially branches into two separate or parallel paths, the first being a right path at 204. At 204, the BPCM 144 receives the measured temperature(s) of the battery module(s) 116 of the battery system 108 from the temperature sensor(s) 148. Again, while only a single temperature sensor 148 may be referenced for simplicity, it will be appreciated that the method 200 could involve the monitoring of measured temperatures from the plurality of temperature sensors 148 (for the plurality of battery modules 116) and thermal runaway monitoring based thereon.

At 208, the BPCM 144 calculates a filtered cumulative temperature change (ΔT). This temperature change ΔT is referred to as a filtered cumulative value as it is maintained or accumulated by a filter (e.g., to remove noise or other short-term fluctuations) having a memory, also known as “a temperature accumulation filter with memory.” This type of accumulation filter allows for the BPCM 144 to track temperature “trends” (changes) and identify potential issues before they escalate. In the case of thermal runaway, once the issue escalates to a certain point, the thermal runaway may be uncontrollable and thus irreparable or non-remediable. At 212, the BPCM 144 determines whether the filtered cumulative temperature change ΔT exceeds a cumulative temperature change threshold (ΔT_{TH}), which could be dynamically determined (online) or predetermined/predefined, such as by an original equipment manufacturer (OEM) of the electrified vehicle 100 or by a supplier of the battery system 108. When false, the method 200 proceeds to 240. When true, the method 200 proceeds to 216. At 216, the BPCM 144 determines whether a temperature malfunction or fault is present indicating invalid measurement from the temperature sensor 148.

As discussed above, however, a very large temperature change caused by an invalid-to-valid transition and the corresponding measured temperature could be observed and inadvertently accounted for by the filter. Thus, this step 216 must account for such situations so as to not inadvertently detect a thermal runaway event (a false positive). This is achieved via the parallel left path that begins at 220. At 220, the BPCM 144 determines whether the temperature malfunction or fault has occurred. As previously discussed, this could be in response to a wireless communication loss or a hardware malfunction. For example, the temperature sensor 148 could temporarily report a temperature of ~0 °C or even a large negative temperature, which the BPCM 144 will know is invalid. When the measured temperature from the temperature sensor 148 is deemed invalid, the BPCM 144 sets the fault active signal HIGH at 224. Otherwise, the BPCM 144 sets the fault active signal LOW at 228, indicating that the measured temperature from the temperature sensor 148 is valid and can be used and relied upon. At 232, the BPCM 144 applies or utilizes a falling edge debounce on the fault active signal as a part of (i.e., an input to) step 216. This design or scheme means that step 216 can only be true after detecting the falling edge of the fault active signal, thereby ignoring any temperature spikes for the duration of the filter.

This prevents the unwanted accumulation of measured temperature change ΔT during invalid-to-valid transitions of the fault active signal for the measured temperature from the temperature sensor 148. In doing so, the above-described spikes in the measured temperature are prevented from causing the rise in the accumulated temperature change ΔT (ΔT_{RISE}) to trigger a false positive thermal runaway malfunction event. At 240, the BPCM 144 determines whether a thermal runaway event has occurred, which is primarily based on the accumulated temperature rise ΔT_{RISE}, but could also be based on other inputs/factors. When false, the method 200 ends or returns to 204 for one or more additional cycles. When true, the method 200 proceeds to 244 where the BPCM 144 (or the control system 136) generates a thermal runaway warning, which could include instructions (e.g., via the driver interface 140, such as a display and/or audio speakers) for occupants of the electrified vehicle 100 to safely exit and move away from the electrified vehicle 100 and the method 200 then ends.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A thermal runaway monitoring system for a high voltage battery system of an electrified vehicle, the thermal runaway monitoring system comprising:
a temperature sensor configured to measure a temperature of a battery module of the high voltage battery system; and
a battery pack control module (BPCM) configured to:
receive, from the temperature sensor, the measured temperature;
generate a high/low fault active signal indicative of whether the measured temperature from the temperature sensor is invalid or valid, respectively;
utilize a falling edge debounce on the fault active signal to control accumulation of a cumulative temperature rise for thermal runaway monitoring of the high voltage battery system; and
detect a thermal runaway event of the high voltage battery system and generate a thermal runaway malfunction warning when the cumulative temperature rise exceeds a cumulative temperature rise threshold,
wherein the utilization of the falling edge debounce on the fault active signal mitigates or eliminates false positive thermal runaway detections caused by the cumulative temperature rise accumulating in response to invalid-to-valid transitions of the fault active signal and spikes in the corresponding measured temperature from the temperature sensor.

2. The thermal runaway monitoring system of claim 1, wherein the BPCM is a wireless BPCM that is configured to wirelessly communicate with the temperature sensor.

3. The thermal runaway monitoring system of claim 2, wherein the BPCM is further configured to, in response to a temporary wireless communication loss between the BPCM and the temperature sensor, set the fault active signal high indicating an invalid measured temperature from the temperature sensor.

4. The thermal runaway monitoring system of claim 3, wherein the BPCM is further configured to, in response to a reestablishment of wireless communication between the BPCM and the temperature sensor after the temporary wireless communication loss therebetween, set the fault active signal low indicating a valid measured temperature from the temperature sensor.

5. The thermal runaway monitoring system of claim 1, wherein the BPCM is further configured to, in response to a wakeup of the BPCM, set the fault active signal high indicating an invalid temperature measurement for a wakeup period.

6. The thermal runaway monitoring system of claim 5, wherein the BPCM is a wired BPCM that is in wired communication with the temperature sensor.

7. The thermal runaway monitoring system of claim 6, wherein the BPCM is further configured to, in response to a hardware malfunction of at least one of the temperature sensor, the BPCM, and a hardwired connection therebetween, set the fault active signal high indicating a valid measured temperature from the temperature sensor.

8. The thermal runaway monitoring system of claim 1, wherein the thermal runaway malfunction warning instructs occupants of the electrified vehicle to safely exit and move away from the electrified vehicle.

9. The thermal runaway monitoring system of claim 1, wherein the temperature sensor is one of a plurality of temperature sensors for a plurality of battery modules, including the battery module, of the high voltage battery system, wherein each battery module comprises a plurality of battery cells, and wherein the BPCM is configured to receive the measured temperatures of the plurality of battery modules from the plurality of temperature sensors and perform thermal runaway monitoring based thereon.

10. A thermal runaway monitoring method for a high voltage battery system of an electrified vehicle, the thermal runaway monitoring method comprising:
measuring, by a temperature sensor, a temperature of a battery module of the high voltage battery system;
receiving, by a battery pack control module (BPCM) and from the temperature sensor, the measured temperature;
generating, by the BPCM, a high/low fault active signal indicative of whether the measured temperature from the temperature sensor is invalid or valid, respectively;
utilizing, by the BPCM, a falling edge debounce on the fault active signal to control accumulation of a cumulative temperature rise for thermal runaway monitoring of the high voltage battery system; and
detecting, by the BPCM, a thermal runaway event of the high voltage battery system and generate a thermal runaway malfunction warning when the cumulative temperature rise exceeds a cumulative temperature rise threshold,
wherein the utilizing of the falling edge debounce on the fault active signal mitigates or eliminates false positive thermal runaway detections caused by the cumulative temperature rise accumulating in response to invalid-to-valid transitions of the fault active signal and spikes in the corresponding measured temperature from the temperature sensor.

11. The thermal runaway monitoring method of claim 10, wherein the BPCM is a wireless BPCM that is configured to wirelessly communicate with the temperature sensor.

12. The thermal runaway monitoring method of claim 11, further comprising in response to a temporary wireless communication loss between the BPCM and the temperature sensor, setting, by the BPCM, the fault active signal high indicating an invalid measured temperature from the temperature sensor.

13. The thermal runaway monitoring method of claim 12, further comprising in response to a reestablishment of wireless communication between the BPCM and the temperature sensor after the temporary wireless communication loss therebetween, setting, by the BPCM, the fault active signal low indicating a valid measured temperature from the temperature sensor.

14. The thermal runaway monitoring method of claim 10, further comprising in response to a wakeup of the BPCM, setting, by the BPCM, the fault active signal high indicating an invalid temperature measurement for a wakeup period.

15. The thermal runaway monitoring method of claim 14, wherein the BPCM is a wired BPCM that is in wired communication with the temperature sensor.

16. The thermal runaway monitoring method of claim 15, further comprising in response to a hardware malfunction of at least one of the temperature sensor, the BPCM, and a hardwired connection therebetween, set the fault active signal high indicating a valid measured temperature from the temperature sensor.

17. The thermal runaway monitoring method of claim 10, wherein the thermal runaway malfunction warning instructs occupants of the electrified vehicle to safely exit and move away from the electrified vehicle.

18. The thermal runaway monitoring method of claim 10, wherein the temperature sensor is one of a plurality of temperature sensors for a plurality of battery modules, including the battery module, of the high voltage battery system, wherein each battery module comprises a plurality of battery cells, and wherein the BPCM is configured to receive the measured temperatures of the plurality of battery modules from the plurality of temperature sensors and perform thermal runaway monitoring based thereon.
